(19) United States
(12) Patent Application Publication
(10) Pub. No.: US 2006/0123428 A1
(43) Pub. Date: Jun. 8, 2006

(54) Network management system permitting remote management of systems by users with limited skills

(75) Inventor: Raymond S. Burns, Newton Centre, MA (US)

Correspondence Address: GORDON E NELSON;PATENT ATTORNEY, PC, 57 CENTRAL ST, PO BOX 782, ROWLEY, MA, 01969, US

(73) Assignee: Nantasket Software, Inc.

(21) Appl. No.: 11/336,017

(22) Filed: Jan. 20, 2006

Related U.S. Application Data
(63) Continuation-in-part of application No. 10/816,290, filed on Apr. 1, 2004.
(60) Provisional application No. 60/645,873, filed on Jan. 21, 2005.
(60) Provisional application No. 60/470,753, filed on May 15, 2003.

(51) Int. Cl. G06F 9/46

(52) U.S. Cl. 719/318

(57) ABSTRACT

A system having a plurality of nodes. Unskilled users of the system may perform certain operations in the nodes using a cellphone-based GUI. A trust value is associated with each user to indicate the extent to which the user is trusted by a manager of the system to perform an operation. The trust value is used to determine whether performance of an operation in a node should be mediated by a managing user. When the user specifies a particular operation on a particular node and the user's trust value so indicates, specification of the operation by the user results in a message being sent to the manager of the system; the action taken by the manager with regard to the message determines how the operation will be performed. Actions include not responding to the message and providing an input to the system in response to the message.

### CROSS REFERENCES TO RELATED APPLICATIONS

The present patent application claims priority from U.S. provisional patent application 60/645,873, Burns, et al., Network management system permitting remote management of systems by users with limited skills, filed Jan. 21, 2005, and is a continuation-in-part of U.S. Ser. No. 10/816,290, Burns, et al., Network management system permitting remote management of systems by users with limited skills, filed Apr. 12, 2004, which in turn claims priority from U.S. provisional patent application 60/470,753, Burns, Wireless network management system, filed May 15, 2003. 60/645,873 and Ser. No.10/816,290 are incorporated by reference into the present patent application. The present patent application further contains the complete Detailed description of Ser. No. 10/817,290. New material has been added at the end of the Description of related art and beginning with the section Improvements in the IWNMS in the Detailed description.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The present invention relates to resolving computer network service interruptions.

2. Description of Related Art

As organizations continue to build their businesses upon computer networks, network and services maintenance becomes increasingly important. Occasionally computer services required by customers or general employees behave unexpectedly or become non-responsive, interrupting those services. Interrupted service costs are in direct proportion to the value of the service and the duration of service interruption: the more valuable the service and the longer the service interruption, the greater the cost to the organization providing the service. Customers may leave a non-responsive service for a competitor's service and organization employees may be idled or switch to lower-priority tasks while waiting for service restoration. The problem is how to restore services in the shortest time possible and to address the underlying problem that caused the service interruption to prevent a recurrence.

Organizations recognize the value of services provided by their computer networks and the cost of service interruptions and vest responsibility for the organization's network resources in an executive officer, the Chief Information Officer (CIO). A staff of technically trained Systems Administrators (SA) may assist the CIO in establishing and maintaining the organization's computer networks according to CIO policies. An organization usually provides External services to customers and business partners and Internal services to employees. Internal services provided by networked computers are increasingly required for general employees (not technically qualified or authorized in computer administration) to carry out their business functions. The CIO is responsible for monitoring the availability of External services and dispatching an SA to resolve External Service Interruptions. In case of an Internal Service Interruption, affected users typically call the “Help Desk”, a dispatch function under the CIO, to dispatch an SA to resolve the Service Interruption.

Economic forces have reduced computer network maintenance budgets (and staffing) at the same time that business reliance on computer networks has increased significantly. As a direct result, a shrinking staff of SA's must resolve Service Interruptions of increasing importance and SA's may be unable to resolve all Service Interruptions before significant costs are incurred.

Computers in a network that behave unexpectedly or become non-responsive are termed Problem Nodes in this document (See Glossary section in Detailed Description, below). In these terms, the problem question may be stated as: how to detect and resolve Problem Nodes before significant costs are incurred?

It is known in the prior art that Problem Nodes may be resolved in three basic ways:

Solution 1) An SA physically travels to the Problem Node and re-starts services or the computer locally. This solution resolves Problem Nodes reliably but is expensive in terms of SA time and opportunity costs (an SA cannot respond to other Problem Nodes while in transit). The costs are only justifiable by comparison; Service Interruptions are generally much more expensive than an SA wasting productive time traveling to and from a Problem Node unless the Problem Node is physically distant. Other disadvantages of this solution are is that a) the method cannot be delegated—only an SA can resolve the Problem Node in this way and b), no audit trail is generated (other than the SA's memory) for later Problem Node analysis and repair.

Solution 2) Remote (or automatic) power-reset device over a secure network connection: This solution also resolves Problem Nodes reliably and much more quickly than Solution 1). The disadvantages are a) the initial capital investment (usually at least 20-30% of the cost of each Node), b) the method cannot be delegated—only an SA can access the device to resolve the Problem Node, c) device access interfaces are normally limited to desktop or laptop computer Nodes, making 24/7 coverage inconvenient, and d) indiscriminate or automatic power resets generate no audit trail for later Problem Node analysis and repair.

Solution 3) Remote computer control over a secure network: this solution also resolves Problem Nodes reliably and often more quickly than Solutions 1 and 2). At the high end, IBM's Tivoli, HP's OpenView and CA's Unicenter provide complete and reliable network management controls across an enterprise. The main disadvantage of this solution is the substantial initial capital investment. Remote Control software packages are in the Mid to Low priced range are far less costly than high-end Network Management packages, but are considerably less reliable than enterprise network management products because these products require that both the Problem Node and a Control Node must have the same software package installed with compatible security options enabled in order to function. As these low-end products provide no means of ensuring that compatible versions Remote Control software are installed on all Nodes providing services to customers and/or employees, an SA cannot rely on establishing a connection to the Problem Node to restore its services using a Remote Control product. Also, these low-end products provide no means of monitoring services or notification of failures; they are designed specifically to control a Node from another Node. b) Low-end products have no means of controlling delegation—only an SA can resolve the Problem Node in this way, c) network management access interfaces are normally limited to desktop or laptop computers, making 24/7 coverage inconvenient and d) network management systems generate no audit trail for later Problem Node analysis and repair.

Therefore, there exists a need to provide more convenient, secure, delegate-able and cost-effective means to monitor Nodes for problems, notify specified users of problem events, and restore Problem Nodes to responsiveness while leaving an audit trail, than the solutions known in the prior art and discussed above. The foregoing need was met by the IWNMS disclosed in the parent of the present patent application, but experience with the IWNMS has revealed a number of problems. One of the problems is with some APs, even the limited access to the managed node provided to the AP by the handsets is too risky; another is the need to download material from the global database to each managed node each time a user connects via handset to the managed node; another is the fact that when an AP restarts a node, there is a period during which the connection to the handset is effectively dead; a final problem was that a managed node had to provide a port for messages from the IWNMS that was always open. It is an object of the present invention to provide an improved IWNMS that solves the foregoing problems.

### BRIEF SUMMARY OF THE INVENTION

The object of reducing the risks inherent in giving some APs even limited access to a managed node is attained by a technique which permits execution of a command by an AP to be mediated by an SA. The technique may be employed in a system that includes a plurality of nodes and is managed by a managing user. The system further has a system operation that may be performed in a node by any user of the system. When a user specifies performance of the method, the system proceeds as follows: it responds to a first input from the user that specifies performance of the operation in the node by obtaining a trust value associated with the user. When the trust value so indicates, the system sends a message to the managing user. The message indicates that the user has specified performance of the system operation in the node. The managing user performs an action with regard to the message that indicates how the system operation is to be performed in the node. The system then responds to the action by performing the system operation in the node as indicated by the action.

Many variations of the above technique are possible. There may be a number of different trust values and the significance of the action taken by the managing user may depend upon the trust value associated with the user. There may also be a number of different actions. For example, the action may be not responding to the message within a predetermined period of time. The predetermined period of time may also be associated with the user. In some embodiments or for some trust values, the action of not responding may indicate that the operation is to be performed for the user; in others, the action of not responding may indicate that the operation is not to be performed.

The action may also be an input from the managing user in response to the message. There may be a number of the inputs, with each input having a different meaning. In some cases, the meanings of the inputs may also depend on the trust value associated with the user.

An example of the variations that are possible is the following: for a given trust value, non-response to the message within the predetermined time means that the system is to perform the operation for the user; if the managing user provides an input during the predetermined period of time, the input may mean either that the operation not be performed or that the operation be performed for the managing user instead of for the user.

One version of the system in which the method is being performed includes a first node which receives the first input. The steps of responding to the first input and sending a message to the managing user are performed in the first node. The step of performing the system operation in the node is performed in the node specified in the first input.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

The foregoing features of the invention will be more readily understood by reference to the following detailed description, taken with reference to the accompanying drawings, in which:

FIG. 1 is a system block diagram illustrating the primary components of a Wireless Network Management System (WNMS).

FIG. 2A illustrates a WAP WNMS Diagram depicting an alternate WAP infrastructure Components in relationship to other components.

FIG. 2B illustrates a technique of adding a wireless interface to a network management system whose primary interface is a wired interface.

FIG. 3 is a system diagram of one embodiment of an IWNMS and its relationship to a WNMS.

FIG. 4 is a system block diagram of one embodiment of the IWNMS detailing the portion resident within a single Managed Computer.

FIG. 5 is a screen shot of one embodiment of the 5-button User Handset interface of the IWNMS. FIG. 5 illustrates the Test Command user interface (left) and the Test Command response (right).

FIG. 6 is a screen shot of one embodiment of the Configure Command user interface (left) and the Configure Command Response (right) of the IWNMS.

FIG. 7 is a flow chart illustrating one embodiment of the operation of the IWNMS.

FIG. 8 provides an overview of the improved IWNMS.

FIGS. 9A and 9B show the AP GUI for the improved IWNMS.

FIG. 10 shows an SA GUI for the improved IWNMS.

FIGS. 11A and 11B show how an SA may configure the improved IWNMS for mediated execution of a command.

FIG. 12 is a flowchart of an exemplary mediated execution of a command.

FIG. 13 is an entity-relationship diagram of tables in IWNMS database 817.

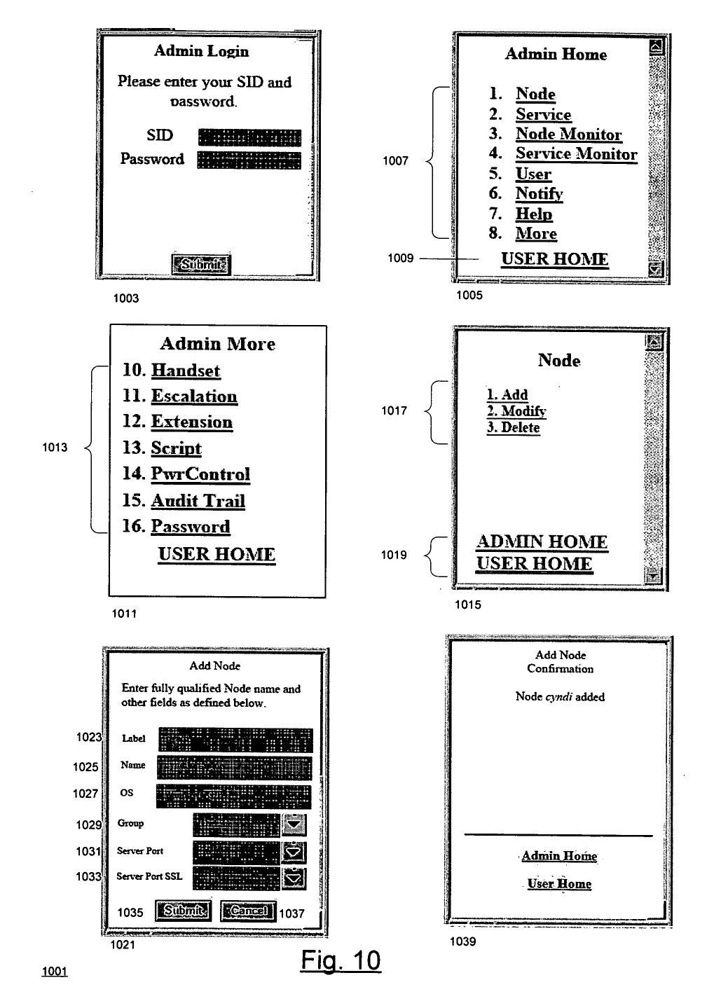

Reference numbers in FIG. 8 and the following drawings have three or more digits: the two right-hand digits are reference numbers in the drawing indicated by the remaining digits. Thus, an item with reference number 803 first appears as item 803 in FIG. 8.

### DETAILED DESCRIPTION OF THE INVENTION

Definitions. As used in this description and the accompanying claims, the following terms shall have the meanings indicated, unless the context otherwise requires:
Administrator (SA): Alternately, Systems Administrator or Network Administrator. Skilled technician trained in computer and network operations and authorized by the CIO to control general user access to Managed Computers and to perform computer network operations within organizational policies.
Administrator Handset: A user handset with a specific User and Command profile set for an Administrator's use. Receives all Event Notifications.
Alert: Console or User Handset status indicating receipt of an Exception Notification event.
Application Level (layer): the highest and most common of network communications protocols. See the OSI model of networking, composed of layers or levels. OSI defines a 7-layer protocol stack, in which each stack layer provides limited functionality to the layer above. Nearly all user requests resolve to Application Level network messages.
Audit Trail: Sequence of User Handset Commands, Command parameters and/or Command results retained in the Global Database and visible from the Administrator's console.
Authenticated User: A handset user who entered the correct handset password in less than the maximum number of retries defined by an SA. See User Authentication.
Carrier Network: telecommunications network where communications between local or distributed nodes using standard wireless, wired and computer telephony protocols. An example is the cellular telephone network provided by Wireless Service Providers (WSPs) that supports WAP and public, and carrier-proprietary security protocols.
CIO: an individual responsible for computing resources and staff, and formulating and enforcing computer resource usage policies for an organization (e.g., commercial, governmental or non-profit) regardless of organization size. In particular, the CIO and SA may be the same person.
Client-server System: a computer and remote resources (possibly other computers or computer networks) connected over a Communications Channel.
Command Profile: a collection of data items associated with a User Profile consisting of a set of commands the user is authorized to invoke.
Communications Channel: a network such as a local or wide area network, telecommunications network or an instance of other types of data communications network that functions using communications protocols.
Compatible Operating Systems: Any computer operating system supported by the present invention, including but not limited to: Microsoft Windows XP, 2000, NT 4.0, Linux, Unix, Macintosh (OSX), Netware, HP-UX, Sun Solaris, Novell Netware, IBM AIX and OS390.
Configured Service: a computer service chosen by the Administrator during invention installation or administration as eligible for control by one or more User Handsets.
Distributed Computer Network: computer network containing component networks implemented with incompatible protocols. Protocol translation may be required between component networks; protocol translation between component networks at specific network levels is typically implemented with Gateways. An example is a network conjoining the Internet and Carrier Networks; both networks use the Transmission Control Protocol/Internet Protocol (TCP/IP) protocol suite, but require protocol translation at the application level to translate Wireless Application Protocol messages into HTTP/HTTPS messages.
Distributed Wireless Network: a conjoined Carrier Network and Distributed Computer Network in which the interface between a Carrier Network and a Distributed Computer Network is a Gateway.
Exception: a condition in which a Managed Computer or one or more Configured Services behaves unexpectedly.
Gateway: a protocol translation device that facilitates bi-directional communications between Nodes on different networks, such as Nodes on a Carrier Network and Nodes on an IP Network.
Health Test: A test of one or more Configured Services or Configured Server/Computers to determine the approximate likelihood of response if the Configured Service or Configured Server were to receive a request.
IP Network: the Internet or any other computer network implemented with Internet protocols.
Managed Computer: any computer with the invention installed that employs a Compatible Operating System and has a persistent connection to the Internet. Communications with a Managed Computer means communications with an instance of the invention installed on a Managed Computer.
Network Management Node (NMN): See Node.
Network Management System: a computer network monitoring and control system in which a network monitoring and control device may receive Exception Notifications from network Nodes and/or the network monitoring and control device may issue asynchronous commands to a Node for execution by the Node.
Network User (AP): A computer user, who may or may not be skilled in network operations, is not normally authorized to perform any computer network operations, but uses one or more computers on the Distributed Wireless Network to perform their normal daily duties.
Node: a User Handset or a Computer connected within a Distributed Computer Network of similar devices.
Problem Node: a Node that fails to respond or responds erroneously to Application Level requests from other Nodes.
Remote Reset Device: one of a class of hardware devices that control power to a computer through a remote connection (e.g., Internet or telecommunications network).
Session: Sequence of invention Control Commands to a Managed Computer beginning with User Authentication and ending with disconnection from a communications network.
User Handset: component of a licensed IWNMS: any handheld wireless communications device that supports “browsing” the Internet. An example of a user handset is a common WAP cellphone, a Java-enabled cellphone, a Personal Digital Assistant (PDA) or other handheld, low-power wireless communications or computer devices.
User Authentication: procedure designed to restrict access to network resources to authorized users. See Authenticated User.
User Status: a collection of data items associated with a wireless handset user that may list the commands invoked and the results obtained during a user Session. The User Profile may contain a reference identifying a handset User Profile as well as other data items.
User Profile: a collection of data items associated with a wireless handset user. The User Profile may contain a reference identifying a Managed Computer license as well as other data items.
WAP Gateway: a Gateway that translates WAP formatted messages (WTLS protocol) into HTTP or HTTPS messages and vice-versa.
Wireless Network Management System: a Network Management System in which the primary hardware interface to the Network Management System is a wireless device, computer system monitoring and control information is exchanged over a wireless communications channel connecting managed computers and the primary hardware interface.

It should be noted that although the embodiment of the invention that is described is with respect to a networked system that is managed by a CIO and SAs, the invention may be applicable to individual computers having an Internet connection that are controlled by a wireless device.

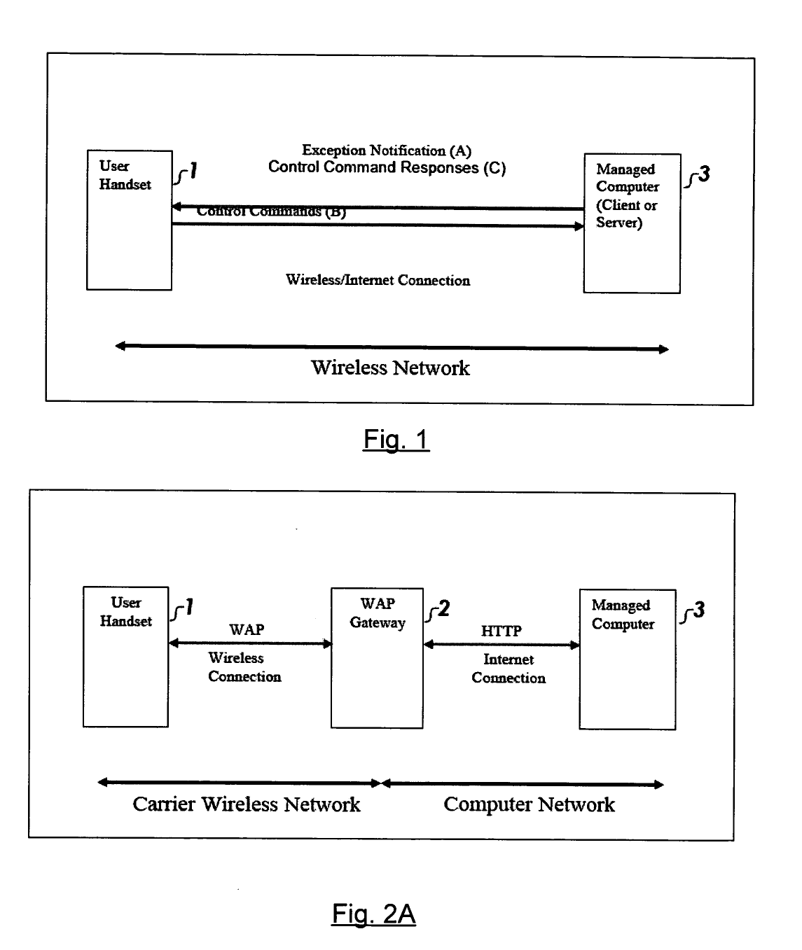

As illustrated in FIG. 1, Exception Notifications and Control Commands are shown as separate unidirectional arrows for clarity. In IWNMS, Exception Notifications (A) and Control Commands (B) are communicated using different protocols. Although the IWNMS uses SMTP/SMS for Exception Notifications, other protocol combinations (such as WAP Push and others) could be used as well. Also, Exception Notifications (A) and Control Command Results (C) may be communicated using different protocols. Although the IWNMS uses HTTP/XML, other protocol combinations (such as WAP/WML) could be used as well.

A single double-headed arrow is used in Figures hereinafter to denote bi-directional wireless communications between WNMS and IWNMS components regardless of the particular protocols employed.

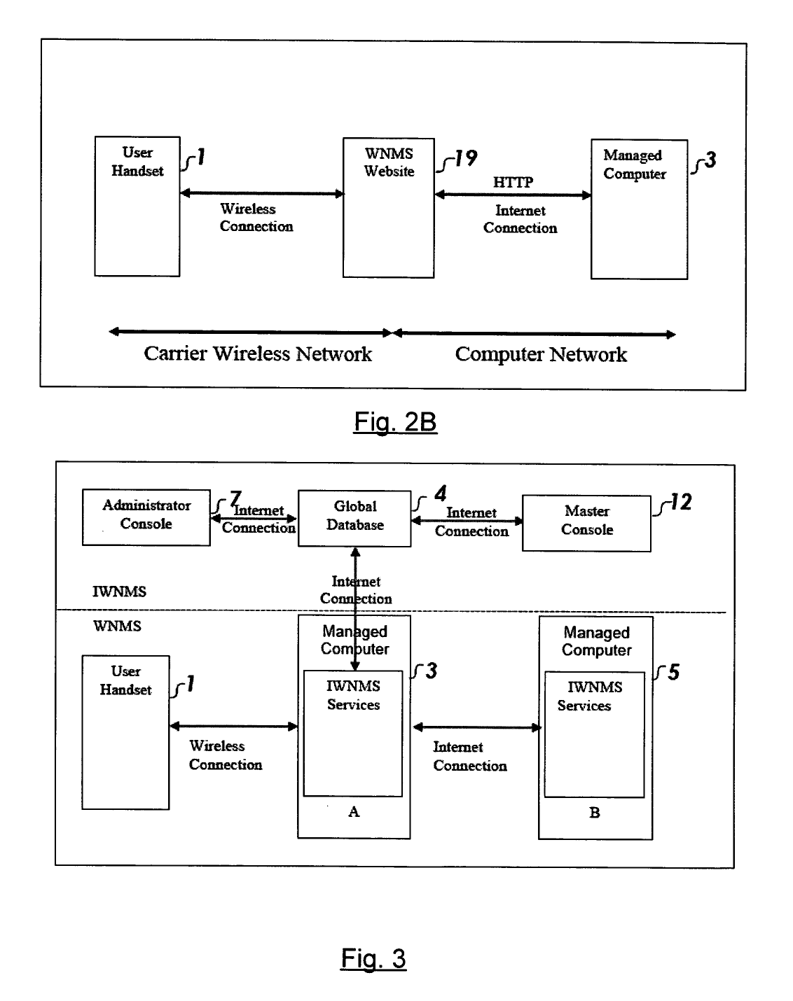

FIG. 1 is a system block diagram illustrating the primary components of a Wireless Network Management System (WNMS). As shown in FIG. 1, a User Handset 1 is in bi-directional wireless communications with a Managed Computer 3 over a wireless network provided by a Wireless Service Provider (WSP). FIG. 1 illustrates direct communication between a User Handset and a Managed Computer; communications do not pass through an intermediary, such as the Wireless Application Protocol (WAP) requires. (See FIG. 2, and the discussion of WAP below). In an IWNMS, an IWNMS component in the Managed Computer 3 notifies the User Handset 1 that an Exception occurred in one or more Configured Services or in a Configured Computer. In response, the authorized user (AP) in possession of the User Handset 1 may select a Managed Computer 3 URL in the User Handset browser. Selection of the Managed Computer URL establishes a secure connection from the User Handset 1 to an IWNMS instance on the Managed Computer 3 and displays a User Authentication prompt for the handset password. The Administrator designated the handset password during IWNMS installation or subsequent IWNMS administration from the Administrator console and gave it to the AP in confidence. On entering the correct handset password, the AP may select from dynamically authorized commands specified in a User Profile to address the exception.

FIG. 2A illustrates a WAP WNMS Diagram depicting an alternate WAP infrastructure Components in relationship to other components. As illustrated in FIG. 2A, WAP communications between a User Handset 1 and a Managed Computer 3 pass through an intermediary WAP Gateway 2. All communications described in reference to FIG. 1, above, occur in a WAP WNMS unchanged except that said communications pass through an intermediary WAP gateway. Consequently, outbound communications from a Managed Computer to the User Handset must comply with the WAP protocol. The indirection adds time delays and a certain degree of unreliability, since the intermediary as well as the User Handset and the Managed Computer must be functioning for communications to occur.

FIG. 2B illustrates a technique of adding a wireless interface to a network management system whose primary interface is a wired interface. A website is created and installed on a wired server that displays static HTML screens with active components for enabled commands. A wireless user selects an enabled component which performs the selected command through the Network Management System standard wired interface, which returns command results to the proprietary website for return to the User Handset. The indirection adds time delays and a certain degree of unreliability, since the intermediary as well as the User Handset and the Managed Computer must be functioning for communications to occur.

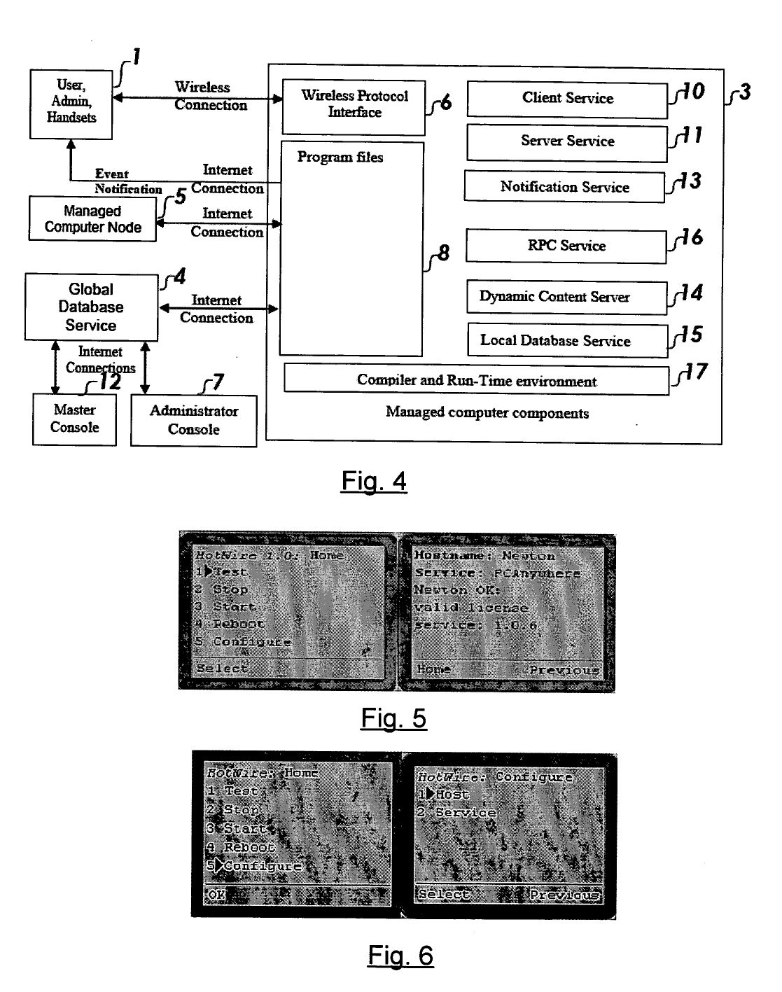

FIG. 3 is a system diagram of an IWNMS and its relationship to a WNMS. The dotted line in FIG. 3 shows the relationship between a conventional WNMS and an IWNMS; IWNMS capabilities are a superset of WNMS capabilities. Although not exact, the dotted line indicates the limits of a WNMS. FIG. 3 illustrates the relationships between the IWNMS (or WNMS) services resident in each managed computer 3,5, the User Handset 1, and Global Database 4. The Wireless Connection between the User Handset 1 and a Managed Computer 3 carries Exception Notifications and Control Commands responses from the Managed Computer 3 to the User Handset 1 and Control Commands from the User Handset 1 to the Managed Computer 3. In FIG. 1, User, Admin, Handsets 1 shows a single box for two distinct but similar devices: Both the User Handset and the Admin. Handsets receive the same Event Notifications; they differ only in that they have different User Profiles. For illustrative purposes, FIG. 3 identifies the network connections between the several components of the IWNMS as “Internet Connection” and “Wireless Connection”. The “Internet Connection” label does not imply that the labeled network connection must use Internet protocols. Other protocols may be used as well, such as X.25, HDLC, PPP, FDDI, and Token Ring (802.5) to name a few. The Internet Connection between the Managed Computer 3 and another Managed Computer 5 carries Control Commands from the Managed Computer 3 to another Managed Computer 5 and Command Results from Managed Computer 5 to Managed Computer 3. For illustrative purposes, the Internet Connection between the Managed Computer 3 and the Global Database 4 carries User Profiles from the Global Database 4 to the Managed Computer 3 and User Status from the Managed Computer 3 to the Global Database 4. The Internet Connection between the Administrator and Master Consoles 7,12 and the Global Database 4 carries User Profiles from the Administrator and Master Consoles 7,12 to the Global Database 4 and User Status from the Global Database 4 to the Administrator and Master Consoles 7,12.

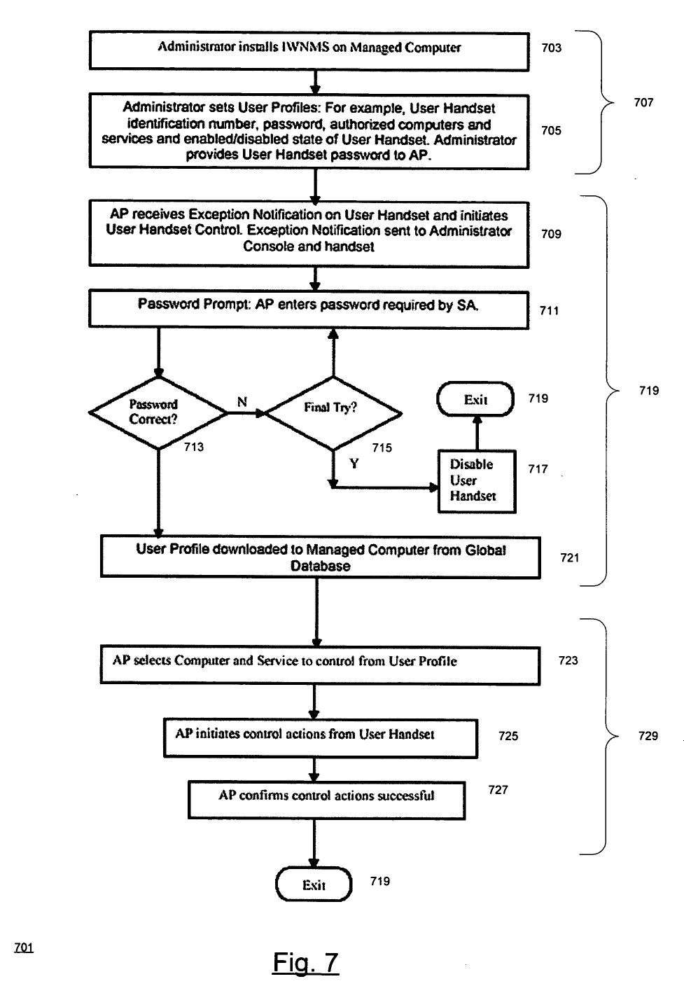

FIG. 4 is a system block diagram of the IWNMS detailing the portion resident within a single Managed Computer: Individual components are summarily discussed below with reference to FIG. 4:

Global Database Service 4: an instance of a database that stores operational settings including license and configuration data in User Profiles in a specified global location on a network. The Global Database Service includes a web server that monitors an Administrator defined port for data traffic. User Profile data stored in 4 is copied locally to 15 during User Handset command sequences. Commands and associated Command Response status codes are returned to the Global Database Service to form an audit trail.

Managed Computer Node 5: another Managed Computer, a Node on a network connected to the Managed Computer.

Administrator Console 7: a graphical user interface that displays Alert status of Managed Computers and provides various controls (e.g., enable and disable User Handsets) as well as duplicates of controls available on User Handsets. Depending on the number of Managed Computers, a given IWNMS installation may have multiple levels of Administrator Consoles 7 displaying appropriate levels of IWNMS granularity. The Administrator Console also may display summarized audit trail data associated with each User Handset.

Master Console 12: a graphical user interface that duplicates the display and controls of multiple Administrator Consoles 7 and may provide controls not available from an Administrator Console.

Wireless Protocol Interface (WPI) 6: the target of the Managed Computer URL; displays a User Authentication prompt for the password contained in the User Profile. The WPI accepts User Handset menu selections, executes selected commands (through calls to other system components), formats User Handset response screens and generates menus for display on the User Handset.

IWNMS program files 8: executable files that implement components mentioned here (7, 10, 11, 12, 13, and 15). 8 is discussed in more detail below. The IWNMS program files check license expiration dates and other critical data at the start of each User Session.

Client Service 10: An instance of a Dynamic Content Server 14 configured as a Service to handle basic communications between the User Handset and the Managed Computer. The client service monitors an Administrator designated, secure port and dispatches an instance of the WPI 6 in response to network traffic on that port.

Server Service 11: An instance of a Dynamic Content Server 14 configured as a Service to handle basic communications requests between the Managed Computer and local or remote Managed Computers Nodes. The Server service monitors an Administrator-defined secure port and dispatches an instance of the RPC Service 16 in response to network traffic on that port. The Server Service returns command results from the RPC service to the User Handset.

RPC (Remote Procedure Call) Service: Executes commands from the Managed Computer as a remote process in a remote Managed Computer Node. The RPC service includes a Native Interface to execute RPC commands in the native operating system of the Managed Computer Node 5. The RPC returns command results from the Managed Computer Node 5 to the Managed Computer Server Service.

Notification Service 13: tests Configured Services health and Managed Computer health at Configured time intervals. Service or computer health is determined by Health Tests. If one or more Health Tests fails Configured threshold values, and the failure is confirmed by subsequent Notification Service tests, the Notification Service sends an Exception Notification (Alert message) to the User Handset that identifies the Managed Computer and/or the Managed Computer service that failed the threshold test.

Dynamic Content Server 14: Web Server that supports dynamic content and serves the Client and Server Services.

Local database 15: an instance of a database that stores User Profiles for a single Managed Computer locally on the Managed Computer. The Local Database Service may include a web server that monitors an Administrator defined port for data traffic. Command choices from the User Handset and associated Command Response status codes may be retained in the local database 15 and uploaded to the Global Database at the end of each Session.

Compiler and run-time environment 17: An instance of a compatible compiler and run-time environment to support Dynamic Content Server 14 and Program Files 8 execution requirements.

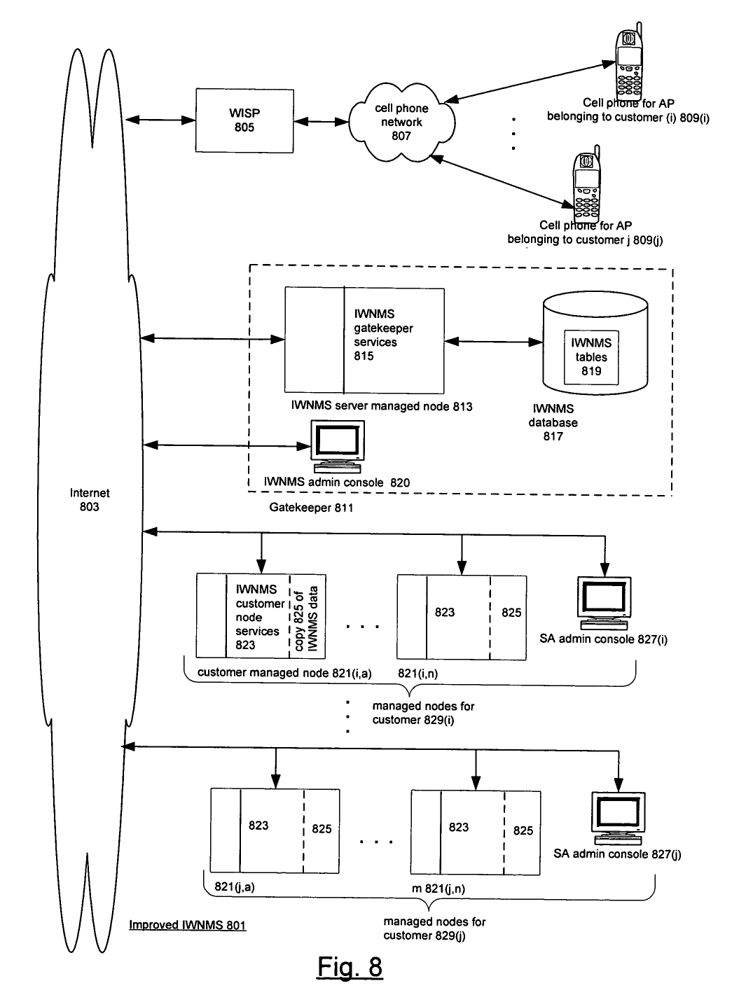

FIG. 5 is a screen shot of the 5-button User Handset interface of the IWNMS. FIG. 5 illustrates the Test Command user interface (left) and the Test Command response (right).

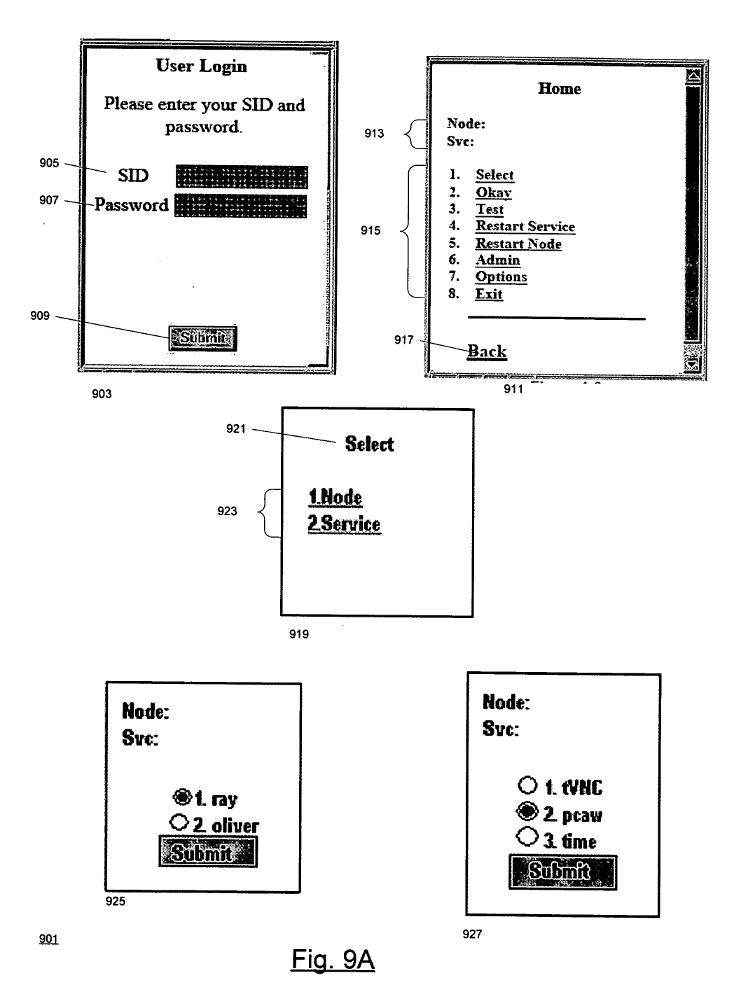

FIG. 6 is a screen shot of the Configure Command user interface (left) and the Configure Command Response (right) of the IWNMS.

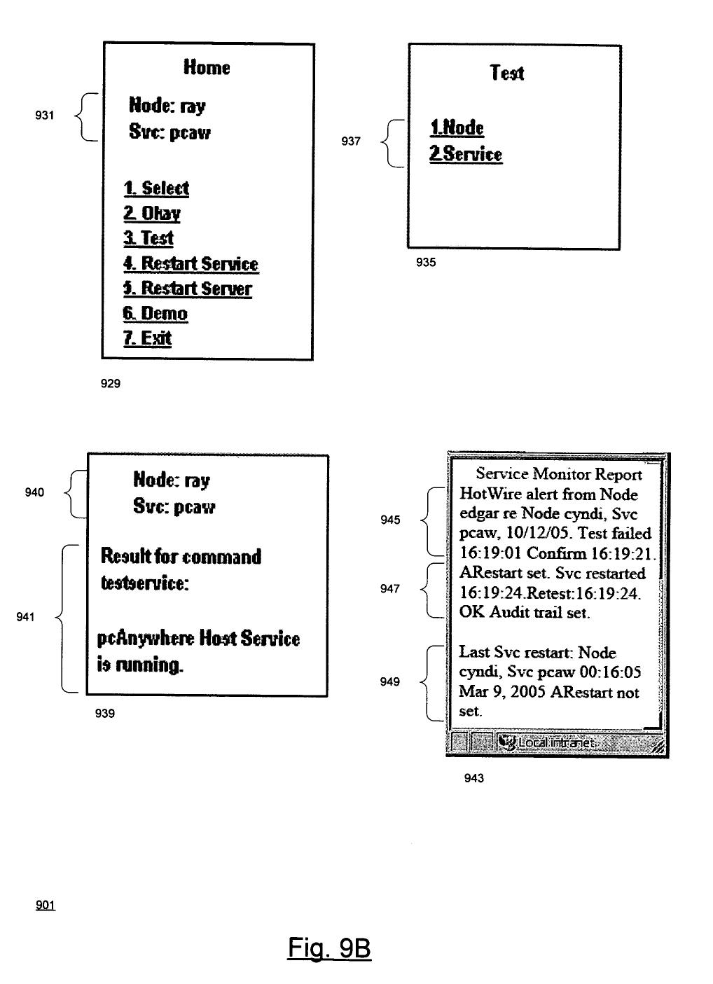

FIG. 7 is a flow chart 701 illustrating operation of the IWNMS. The first stage of the operation is the initialization 707 of the IWNMS on a managed computer 3. First, an administrator installs IWNMS on the managed computer 3 (703). Then, after the software is installed, the administrator sets user profile information (705). This can be done either during installation or from administrator console 7 any time after the installation has been completed. The user profile information set at this time includes at least enough user profile information to permit the managed computer 3 to send a message to a handset 1 and to verify a password received in a message from the handset. The administrator also provides the password to the AP who is to use the handset. The administrator may download new user profile information at any time after the IWNMS software has been installed on managed computer 3.

The next stage of the operation is the interaction 719 between handset 1 and managed computer 3 which establishes a session between handset 1 and managed computer 3. Interaction 719 begins at 709 when the AP who is in possession of handset 1 initiates handset control of managed computer 3. Step 709 may be performed in response to an exception notification message which IWNMS sends handset 1 in response to an exception which has arisen in managed computer 3. The information needed to send the exception notification message comes from the user profile information which was downloaded at step 705. Managed computer 3 also sends the exception notification to administrator console 7.

When handset 1 contacts managed computer 3, managed computer 3 operates under IWNS control to provide a password prompt to handset 1 (711). The AP then enters the password he or she received from the system administrator. If the entered password agrees with the one for the handset that was provided in step 705, the next step is step 721. Otherwise, a number of retries are permitted (715) and when the maximum number specified in the downloaded user profile information is reached, managed computer 3 sets the user profile information to indicate that handset 1 has been disabled, sends a message indicating that fact to administrator console 7 (717), and exits IWNMS.

In step 721, IWNMS downloads current user profile information for managed computer 3 and handset 1 identified by the password and identification number downloaded in step 705 from global database 4. The current user profile information specifies at least the kind of control which the AP can exercise over managed computer 3 from handset 1. Because step 721 is performed at the beginning of any session between handset 1 and managed computer 3, any change which the administrator has made prior to the downloading in global database 4 regarding the kind of control which the AP can exercise over managed computer 3 from handset 1 is effective for the session.

The final stage 729 is the interaction between handset 1 and managed computer 3 that occurs during the session established in interaction 719. Based on the current user profile information downloaded in step 721, the IWNMS software provides a menu to the handset like the ones shown in FIGS. 5 and 6. The menu lists the managed computers that the current user profile permits the AP to control and lists for each managed computer only those operations which the current user profile indicates that the AP may perform on that managed computer. The AP then selects the computer and the operation from the menu (723) and initiates the specified operation (725). Having selected and initiated the operation, the AP can then specify a test to confirm that the operation has been successful (727). Interaction 729 may be repeated for a number of different managed computers or operations. When the AP has performed all of the desired operations, the AP terminates the session. Upon termination of the session, the IWNMS software logs the results of the session and terminates. Global database 4 periodically reads the software logs and updates its user profile information as required.

In an alternate embodiment of the IWNMS, the SSH (Secure Shell) protocol is used to communicate between the User Handset 1 and the Managed Computer 3 and to encapsulate Client 10, Server 11 and RPC 16 Services.

The IWNMS is client-server software that installs on Managed Computers and on User Handsets and enables authorized user(s) to securely monitor and control remote computer services and restart Managed Computers from the User Handset within limits specified dynamically by the Administrator. (See the Glossary for specialized definitions of capitalized terms).

In the IWNMS, the process described above is used to implement bi-directional wireless communications between the User Handset, the Managed Computer and the Global Database, enabling authorized user(s) to monitor and securely control the Managed Computer, configured Network Nodes and their configured services from a User Handset within organization policy limits and Administrator defined control definitions. IWNMS communications between the User Handset, the Managed Computer and Network Nodes uses HTTPS and HTML and Extensible Markup Language (XML), but other protocols such as HTTP and STML may also be used.

In an alternative embodiment, the process described above is used to implement bi-directional wireless communications and control enabling authorized user(s) to monitor and securely control remote computer(s) and services from a User Handset within organization policy limits and Administrator defined control definitions over the Wireless Application Protocol (WAP).

As shown in FIG. 2, inexpensive User Handsets that support WAP require a WAP Gateway (provided by the WSP) to establish a connection between a User Handset and a Managed Computer. In this embodiment, the User Handset communicates to the WAP Gateway using an alternative language, Wireless Markup Language (WML) versus communicating directly to the Managed Computer in HTTPS and HTML or Extensible Markup Language (XML) as can be used with a non-WAP phone capable of browsing.

Program files: the logic required to support 1, 4, 7, 10, 11, 12, 13, and 14 is implemented in Program files 8 and the Wireless Protocol Interface 6. These components are discussed in detail below:

Wireless Protocol Interface: 6 the Client Service 10 launches WPI when the AP selects the Managed Computer URL on the User Handset 1, beginning a Session. The WPI is responsible for AP User Authentication, executing User Handset commands and displaying command results on the User Handset interface. In IWNMS, the WPI 6 displays a menu on a User Handset to an Authenticated User. (See FIG. 5: User Handset Interface).

User Interface controls: The number of controls and control meaning may be modified by a Managed Computer SA at any time by modifying the User Profile fields through the Administrator Console 7. For the following IWNMS discussion, assume that the configured User Profile specifies a User Handset interface configured with five (5) menu selections (controls): Test, Stop, Start, Reboot and Configure. These selections are sufficient to control services on a remote Managed Computer within limits established by a Managed Computer SA.

In IWNMS, computer fully qualified names and full service names are not shown on the User Handset unless an SA chooses to do so. During installation or subsequent administration through the Administrator's console, a SA chooses labels that are displayed instead. For example, if the fully qualified computer name was “sql.igsw.com”, the SA might use the label DBSvr. Similarly, the SA may use the label “DBSrvc” instead of “MSSQLServer”.

In this example, the meaning of the first four controls (Test, Stop, Start, and Reboot) is modified by the last (Configure) control. That is, if “Newton” is the configured computer label and “pcaw” the configured service label, then
Test runs basic Health Tests on Managed Computer “Newton” (See FIG. 6: User Handset Interface for the result screen (right illustration)),
Stop stops the pcaw service on computer Newton,
Start starts the pcaw service on computer Newton,
Reboot reboots computer Newton.

Configure allows the user to choose a Managed Computer (host) and managed services from choices determined by a systems Administrator (SA). Configuration changes of host and/or service are uploaded to the Global Database.

User Handset caching: many User Handsets implement command caching. That is, the User Handset keeps a record of each command it sends over the wireless link in a local cache and searches the cache for commands it is about to send. This caching procedure is meant to conserve scarce resources and improve apparent response time by not transmitting redundant commands. In the case of dynamic content, such as the one the IWNMS confronts, identical sequential commands may be required that may yield new data at each invocation. To ensure transmission of each command, redundant or not, the IWNMS defeats User Handset caching. There are several means of defeating User Handset caching; for illustrative purposes, this description assumes the technique of appending a random number to each command string sent to the User Handset to defeat caching.

Program Files 8:

WPI: Implements WPI 6. WPI performs User Authentication and executes User Handset Commands. WPI is a combination of User Authentication and User Handset command execution methods. The Dynamic Content Server 14 detects User Handset traffic and launches a WPI instance with a Request and Response Object. The Request object encapsulates HTTP/S request information contained in the User Handset traffic. The Response Object contains methods to write output to the User Handset display. WPI command execution logic consists of a Command Dispatcher and Command Execution methods. The WPI dispatcher retrieves a command name from the Request object, dispatches a method to service the command and writes command output to the User Handset using Response Object methods. Since command names and parameters are dynamic, all references to command names and parameters are resolved through a User Profile in the Local Database.

On initial WPI entry, WPI dispatches the User Authentication method. User Authentication logic is illustrated in FIG. 7. A system variable, persistent only for the current Session, is set to indicate User Authenticated status following successful User Authentication.

User Handset commands may be accepted for execution following successful User Authentication. WPI is dispatched with a command name that was selected from the User Handset User Interface. The WPI dispatcher accesses parameters passed from the User Handset to the Dynamic Content Server 14 by reference to the Request object and to the User Profiles in the Local Database. 15.

Display data returned by command methods differs for different wireless protocol transports supported by the present invention. For illustrative purposes, the balance of this section assumes the Wireless Application Protocol (WAP).

GUI: implements Administrator and Master Console User Interfaces with reference to the Global Database to distinguish functions and screens available by console type. In IWNMS, the Administrator Console may perform the same functions from the Managed Computer that the IWNMS performs from the User Handset and may perform additional functions defined by an Administrator Profile in the Global Database. A Master Profile in the Global Database defines valid Master Console functions (a superset of Administrator functions).

ITimer: a general-purpose interval (watchdog) timer that supports GUI connections. Used by multiple classes.

RPC: wraps RPC methods in a thread for independent scheduling.

Server: wraps the Server Service class, implements and schedules the RPC remote command execution class that executes command line commands on remote Managed Computer Nodes 5.

EnDecrypt: file and stream encryption and decryption methods and decryption class loader. Program files are stored in encrypted form on the Managed Computer. EnDecrypt class loaders load decrypted classes into the Run-Time environment.

GlobalDatabase: methods to access Global Database tables and data items within tables. Inserts new data items, selects and updates data items in Global Database tables.

refreshLocalDatabase: downloads User Profiles from tables in the Global Database to Local Database tables. Inserts new data items into tables, selects and updates data items in tables in the Local Database.

licenseRegistration: installation support class. Inserts installation User Profile into Local Global Database tables from data gathered during installation process.

localDatabase: methods to access Local Database User Profiles (tables and data items within tables). Inserts new data items into tables, selects and updates data items in tables in the Managed Computer Local Database.

CheckSum: calculates and returns file checksums and sends notification of mismatch to designated recipients. Used by Common methods to detect data or Program file corruption and to alert the AP, the Administrator and Master Consoles if data or Program file corruption occurs. CheckSum calls the Notification Service message formatter to format a CheckSum failure Event Notification message that is immediately sent to the Notification Service for delivery to the User Handset. Also, the CheckSum failure status in the Global Database is set true, causing the Administrator and Master Consoles to indicate CheckSum failure status identifying the corrupt file name and path.

primeLocalDatabase: installation support class. Inserts new User Profile data items into tables in local database gathered during installation.

notification: Performs Health Tests of Administrator designated services and computers at Administrator designated time intervals. If the Health Test fails for a specified service or computer, and the failure is confirmed by an Administrator-specified number of repeated tests, the Notification Service notifies the user with an Event Notification, identifying the service and or computer that failed. Notification is a combination of a notification task dispatcher, routines to test configured services, a message formatter and message server. The notification task dispatcher queries the Local Database for the Managed Computer name and all configured service names, then dispatches routines to perform Health Tests of the configured computers and each of the configured services on the Managed Computer at Administrator-specified time intervals.

The Managed Computer Health Test sends network messages to the Configured Computers and notes response times. If the response time exceeds an Administrator-specified time interval, the test is counted as a failure. The Configured Service Health Test runs a native operating system routine to identify running services. If the Configured Service is not listed, the test is counted as a failure.

If a Health Test fails, the failure is confirmed by an Administrator-specified number of repeated Health Tests. If the failure is confirmed, the message formatter is called to format an Event Notification message specifying a computer or service failure. The Event Notification message (Alert) is sent to the Notification Service for delivery to the User Handset.

Common: collection of methods common to multiple classes.

Improvements in the IWNMS

Varieties of the IWNMS in the Parent

In the parent, four varieties of the IWNMS are disclosed: FIG. 1 shows a variety in which the user handset 1 and the managed computer 3 both have direct access to a digital wireless network which can carry messages that obey protocols belonging to the Internet protocol suite. As specified in FIG. 1, managed computer 3 may be either a client or server. FIG. 2A shows a variety in which the user handset has access to the Internet via a wireless access gateway. FIG. 2B shows a variety in which a WNMS website 19 has wireless connections to user handsets 1 and Internet connections to managed computers 3. Website 19 provides the HTML GUI used by the user handsets. FIG. 3, finally, shows a variety in which a managed computer 3 functions as a server with regard to user handset 1 and as a client with regard to managed computer 5. A user of the IWNMS may use user handset 1 to send a message to managed computer 3 which specifies a command to managed computer 5. When managed computer 3 receives the message, it uses global database 4 to determine whether the user of handset 1 has the right to make the command specified in the message to managed computer 5, and if the user does have the right, the managed computer provides the command to managed computer 5, receives the command results from managed computer 5, and sends a reply message to handset 1 indicating the command results.

An Improved IWNMS: FIG. 8

FIG. 8 provides an overview of improved IWNMS 801. The main components of IWNMS 801 communicate with each other via Internet 803, i.e., each of the components has an Internet address and can send and receive messages that obey protocols belonging to the Internet protocol suite. In other embodiments, other networks and network protocols might be used instead. As before, IWNMS 801 permits a user of a handset 1 who has the right to do so to issue a command using the handset to a managed computer 3 or 5 and to receive notifications from a managed computer 3 or 5. In the following, the managed computers are termed managed nodes. Improved IWNMS 801 has a new component, however. The new component is gatekeeper 811, which is a version of WNMS website 19 of FIG. 2B that includes a managed node that works like managed computer 3 of FIG. 3. That managed node appears in FIG. 8 as IWNMS server managed node 813 and IWNMS database 817 which is equivalent to global database 4. Managed nodes that stand in the same relationship to managed node 813 as managed computer 5 does to managed computer 3 appear in FIG. 8 as customer managed nodes 821.

As mentioned in the discussion of FIG. 3, handset 1 provides a general purpose GUI for providing commands to and receiving notifications from managed computers. The user of a handset may be an AP belonging to a customer, a system administrator belonging to the customer, or a system administrator belonging to the entity that provides the IWNMS In general, an AP may only issue commands affecting specific ones of the customer managed nodes 821 for the customer the AP belongs to. The customer system administrator may further issue commands that configure the IWNMS for the customer's users and managed nodes; the effect of these commands is to modify the information in database 817 for the customer. The IWNMS administrator may further issue commands that administer the configuration of the IWNMS with regard to customers generally. In the following, the term user will embrace APs, customer administrators, and IWNMS administrators, and the term SA will embrace both customer administrators and IWNMS administrators.

All of the users have the same basic GUI, but the kinds of commands that may be issued and the kinds of notifications that will be received depend on whether the user is an AP, a customer system administer, or an IWNMS administrator. Moreover, any user may employ any device which is capable of executing the GUI to issue commands and receive notifications. Thus, an SA will typically have an administrative console instead of a handset. In the following, devices which can execute the GUI are termed GUI devices. Two kinds of GUI devices appear in FIG. 8: handsets 809 and administrative consoles 820 and 827.

In improved IWNMS 801, when a user of a handset 809 issues a command to a particular managed node 821, the handset addresses the message containing the command to gatekeeper 811. The message goes via cell phone network 807, wireless internet service provider 805, and Internet 803 to IWNMS server 815, which uses IWNMS database 817 to determine whether the user of the handset 809 has the right to issue the command and if the user does have the right, sends the command on to the managed node 821 for which it is intended. When the command has been executed, the managed node 821 sends a notification of the results to the handset 809 from which the command came. Improved IWNMS 801 works in generally the same way with commands from and notifications to any user GUI device; thus, with administrative consoles 820 and 827, the commands and notifications are sent from and to the consoles. As in the system of FIG. 3, notifications indicating the status of a managed node may also be generated by a managed node independently of the receipt of a command.

Continuing in more detail with Gatekeeper 811, IWNMS server 813 is a managed computer 3 which includes a version 815 of IWNMS services that includes services used by SAs to configure managed nodes for customers and to configure the improved IWNMS as a whole. These services generally modify IWNMS database 817. Services 815 also include code for keeping the copies 825 of information from database 817 current with database 817. Gatekeeper 811 further includes IWNMS administrative console 821, which is a GUI device used by administrators of gatekeeper 111 to execute management services in gatekeeper 811.

Each customer 829 of IWNMS 801 has a set of managed nodes 821 containing managed computers, a set of cell phones 809 which are known to gatekeeper 821 which are GUI devices used by users of IWNMS 801 who belong to customer 829, and an administrative console 827 which is a GUI device that the SA for the customer uses to administer the managed nodes belonging to the customer. Cell phones 809, managed nodes 821, and administrative consoles 827 for two customers, customer 829(i) and customer 829(j), are shown in FIG. 8 Users belonging to customer 829(i) can issue commands from cell phones 109 belonging to customer 829(i) to manage the managed nodes belonging to the customer. Each managed node 821 includes IWNMS node services 823, which is a version of IWNMS services which is adapted to be used in a managed node. For example, IWNMS node services 823 do not contain services which determine the users who have access to the managed node 821 or services for modifying IWNMS database 817. Each managed node may also include a copy 825 of portions of the information in IWNMS database 817 which are relevant to the node. For example, if the managed node has been configured to send notifications, the information needed to make and send the notifications is contained in copy 825. Certain critical information in copy 825 is checked before a command is executed to determine whether it is still identical with the information in IWNMS database 817 of which it is a copy; if it the information in the copy is not identical, it is automatically updated from IWNMS database 817 before the command is executed. An example of such information is whether the cellphone which is the source of the command is enabled for use in IWNS 801. IWNS gatekeeper services 815 include services that keep the contents of copies 825 consistent with IWNMS database 817.

Configuring IWNMS 801

IWNMS 801 is configured by adding, modifying, or deleting information from IWNMS database 817. Configuration may be done by users who are SAs, with what can be configured depending on whether the SA is a customer SA or an IWNMS SA. Entities that can be configured include:
Customers and their licenses: who the customer is and what licenses in IWNMS 801 the customer has. A license may be associated with one or more GUI devices. Each command from a GUI devicespecifies the license the GUI device is associated with. Each license is identified by a value called a SID. Customers and licenses can be configured only by IWNMS SAs.
Handsets: a handset can be configured with a unique identifier for the license it is running under, for the name of the user who will be using it, its telephone number, its wireless service provider name, and whether it is enabled.
Users: a user can be configured with a unique identifier for the user, the user's wireless service provider, a trust index for the user, which indicates how much the SA who configured the user trusts the user, a trust time out, the telephone number for the user's handset, contact information for the user, and whether the user is enabled.
managed nodes: a managed node is configured with the license the node is under, the name of the node, its operating system, the connection to the node used by IWNMS 801, and whether the node is a customer managed node 821 or an IWNMS server managed node 813.
node monitors for nodes. A node monitor is configured to monitor the behavior of a node by running a particular test on the node. The code for the test is in the node's IWNMS data 825. The node monitor also writes the test and its result to the audit trail maintained by IWNMS 801.
services: a service is a program that runs continuously on a managed nodeunder the auspices of the native operating system. A service running on a particular managed node may be configured to be monitored by the IWNMS.
service monitors for services. A service monitor is configured to monitor the behavior of a particular service on a particular node by running a particular test on the particular service. The code for the test is in the node's IWNMS data 825. The service monitor also writes the test and its result to the audit trail maintained by IWNMS 801.
tests: programs executed by node monitors and service monitors to determine the conditions of their respective nodes and services.
notifications: messages generated when commands are executed or a node monitor or a service monitor executes A notification may be configured to indicate the user to notify, how a notification is to be escalated, and to whom it is to be escalated.
access for commands: IWNMS 801 is configured to indicate for each user the nodes and the services on those nodes which the user may issue commands for. If IWNMS 801 is not configured so that the user can perform the command, IWNMS server managed node 813 will bar performance of the command.
   Advantages of Improved IWNMS 801

As already pointed out, in IWNMS 801, any command issued by user of IWNMS 801 must go first to IWNMS server managed node 813 in gatekeeper Web site 811. IWNMS server manage node 813 consults IWNMS data base 817 to confirm the right of the user to access IWNMS 801 generally and to perform a particular command on a particular node before providing the command to the node. A number of advantages flow from thus using IWNMS server managed node 813 to mediate every access by a user to IWNMS 801:
Access control information need not be downloaded to the customer managed nodes 821;
During the execution of a command, IWNMS server managed node 813 is always available to both user GUI device 809 and customer managed node 821. This has two advantages:
   If a user whose user interface device 809 is communicating directly with a managed node 821 restarts the node, the connection to user interface device 809 goes dead while the node is being restarted, but the user's connection to node 813 remains alive.
   There need not be a continually-open port in managed node 821 to receive messages containing commands from user GUI interface devices belonging to IWNMS 801.

Instead, IWNMS gatekeeper services 815 can send a message via the port used for the managed node 821's browser indicating to IWNMS node services 823 that a message is waiting, and at that point, IWNMS node services 823 can open a port for the command message and send a message to IWNMS gatekeeper services 815 indicating that the command message is to be sent to that port. The newly-opened port can be used for the messages resulting from the execution of the command in the command message and then closed.

GUIs for the Improved IWNMS

The GUIs for all users of IWNMS 801 are similar; what distinguishes the GUI for an AP, the GUI for a customer SA and the GUI for an IWNMS SA from each other is the operations that can be performed from the GUI and the notifications that will be received in the GUI.

As will be seen from the following discussion, there are two broad classes of operations: commands, which specify test and restart operations on nodes and services, and configuration operations, which configure IWNMS 801. Examples of the AP GUI and the customer SA GUI are provided in the following.

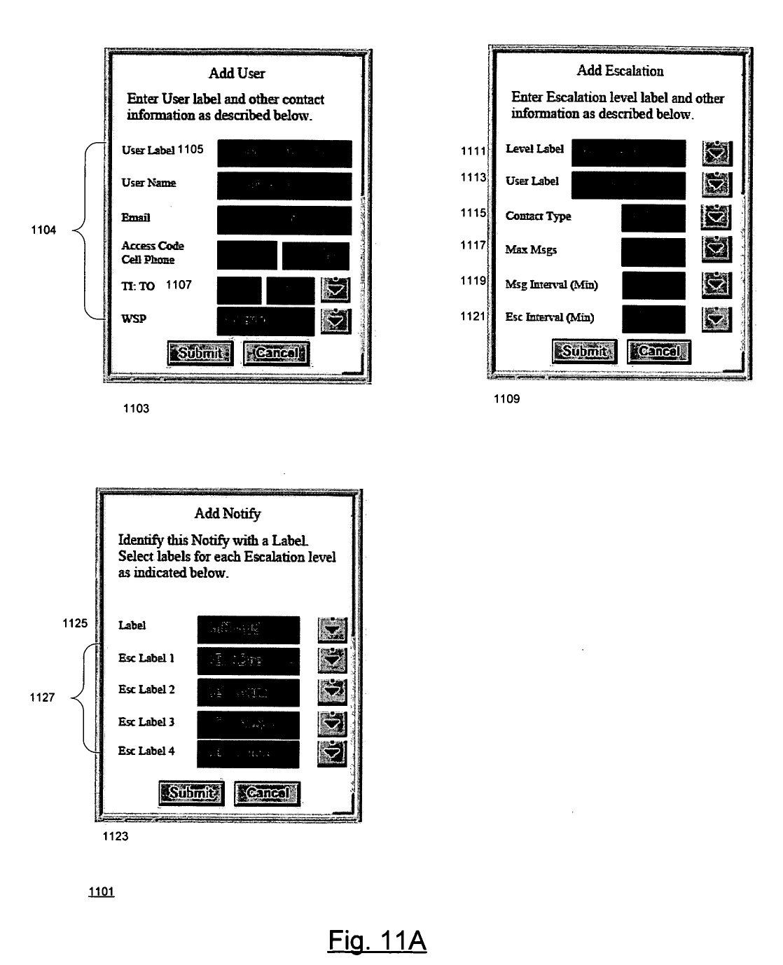

The AP GUI: FIGS. 9A and 9B

Exemplary screens from AP GUI 901 are shown in FIGS. 9A and 9B. All users of IWNMS 801 must log onto IWNMS 801. The logon screen for all users of IWNMS 801 is shown at 903. In order to log on, the user must provide an SID 905, which is an identification number associated with the license that the user is using the IWNMS under, and a password 907 that identifies the user. The IWNMS SA assigns SIDs to customer handsets and the customer SA assigns a password to users belonging to the customer and provides the SID and the password to a user along with the handset. When the user clicks on submit button 909, the logon message goes to gatekeeper 811, which only permits the user to log on if the SID matches the SID for the license that the handset has been assigned to and the password matches the password that the SA has assigned to the user

If the User login is successful, Home screen 911 appears on the AP's user GUI device. There are two parts of screen 911: at 913 are indicated the node and service the command is to be applied to; here, none has yet been selected. Menu 915 lists the operations which the AP may perform. The operation is performed upon selection of the item in the menu:
Select is used to go to a screen which permits the user to select a node or service on a node to which a command is to be directed.
Okay acknowledges notifications destined for the user GUI device. Selecting Okay cancels sending notifications to the user GUI device for a period of time specified by the customer SA.
Test goes to a screen which permits the AP to command that a node or service be tested by the IWNMS;
Restart Service results in a command to IWNMS to restart the service selected in the select screen on the node selected in the select screen.
Restart Node results in a command to the IWNMS to restart the node selected in the select screen.
Admin is used to go to an administrative login screen. Login on that screen is possible only if the user is either a customer SA or an IWNMS SA.
Options is used to go to a screen from which the user may select additional operations in nodes that the IWNMS SA has made available to users belonging to the customer.
Exit returns to the User Login screen.

As may be seen from the foregoing, in a preferred embodiment, the commands which may be issued by an AP include only commands to test a selected node or service, to restart a node or service, or a command which is specified on the options screen.

Screens 919 through 927 show how the AP selects the node or service to which the command applies. Screen 919 appears when the user clicks on Select in screen 911; the name of the operation to be performed by the screen appears at 921 and the menu of possibilities appears at 923. The screen at 925 appears when the AP selects Node from menu 923; The customer to whom the AP belongs has two customer managed nodes 821, ray and oliver. In screen 925, the user has selected the node named ray. When the user clicks on Submit, screen 919 reappears; if the user selects service on that screen, screen 927 appears, with a list of the services that the AP may manage on the node ray. Here, the user has selected the service pcaw, which is a pcAnywhere® program running on the node ray. When the user clicks on Submit, screen 929 appears, which is like screen 911 except that as a result of the select operation, the node and service are now specified at 931.

Having specified the node and if necessary for the command, the service, the AP can now select a test to be performed on the node or service or command that the service or node be restarted from menu 915. At 935 is shown the screen that appears when test is selected. At 937 is a further menu from which the user can select either the node or the service specified at 931 for testing. Before the test is performed, IWNMS server managed node 813 determines whether the AP has access to the specified node and service, and performs the test only if the AP has access. Access checks are of course also made prior to restarting a service or node. Screen 939 shows the notification that the test was performed and that the service is running. The node and service upon which the test was performed are shown at 940, and the message returned by the notification is shown at 941. Screen 943, finally, shows a notification returned to a user GUI device by a service monitor. At 945, the notification indicates that the pcaw service failed a test made by the service monitor in node cyndi and that the failure of the test was confirmed. At 947, the notification indicates that automatic restart was set for pcaw and the service was automatically restarted. After the service was restarted, it was tested again and the test was OK. An audit trail of the failure and restoration of the service in the node was made. At 949, finally, the notification returns information from the audit trail about the last failure of the service in the node.

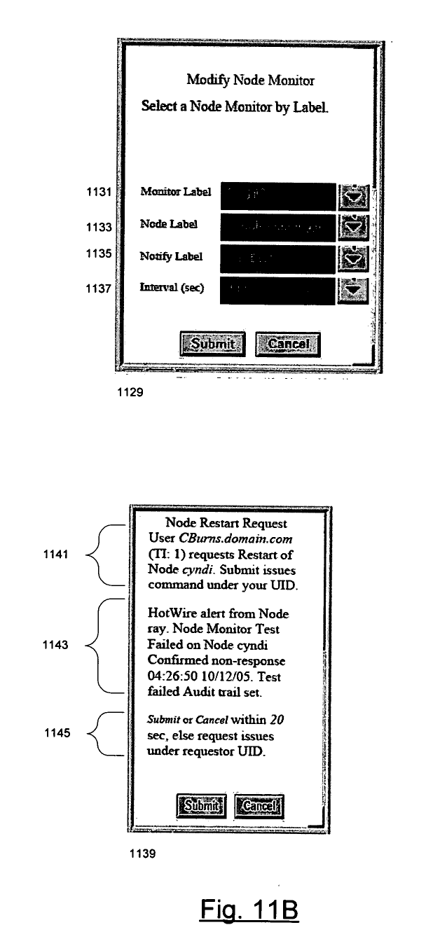

The Customer SA GUI: FIG. 10

If a user is an SA, the user logs in by first logging in using User Login screen 903 and then selecting Admin in user Home screen 911. If IWNMS server managed node 813 confirms that the user is a customer SA, the Admin Login screen 1003 appears, and the user enters the SID and a separate administrative password that is assigned by the IWNMS SA and clicks on submit. IWNMS server managed node 813 confirms that the password belongs to the administrative user and then displays Admin Home screen 1005. The screen includes a part 1007 of the menu of operations available to a customer SA and a USER HOME label which, when clicked on, takes the user back to screen 911. To view the remainder of the operations available to him or her, the customer SA clicks on the More item in menu 1007. Doing so causes screen 1011 to appear with the remainder 1013 of the menu of operations.

As can be seen from the portions 1007 and 1013 of the operations, the operations are for the most part configuration operations. Thus, the SA selects Node to add, modify, or delete a managed node from IWNMS 801, Service to do the same with a service, Node Monitor to add, delete or modify a node monitor, User to do the same with a user, Notify to do the same with a notification, Escalation to define who is to first receive a notification and how the notification is to be escalated if the first or later addressees to not respond, PwrControl to configure nodes to be powered down and back up, Audit Trail to configure how events such as tests and commands are to be recorded in the audit trail; Password to assign a password to an AP, and so forth.

The remaining screens in FIG. 10 provide an example: they show what happens when the SA selects Node from screen 1005. Node operation screen 1015 then appears. Menu 1017 permits the SA to select among add, delete, and modify operations on nodes, and the labels at 1019 permit the SA to return either to Admin Home screen 1005 or user Home screen 911 Screen 1021 shows the Add Node screen 1021 that appears when the user selects the Add operation in screen 1015. When the SA adds a node, he or she specifiesa name by which the node shall be known in the IWNMS in field 1023; at 1025, the SA specifies the node's fully-qualified name in the network to which the node belongs; as 1027, the SA specifies the node's operating system.

Fields 1029-1033 may be set using drop-down lists of possibilities. Group field 1029 specifies what subgroup of the nodes belonging to the customer the node being added is to belong to. Server Port field 1031 specifies the port for IWNMS customer node services 803 in the node being configured. SSL field 1033 specifies whether the port selected in field 1031 is a Secure Socket Layer port. When the SA is finished configuring the new node, the user selects Submit 1035, which causes IWNMS gatekeeper services 815 to add the new node to IWNMS database 817. When the node has been added, gatekeeper services 1015 return the notification shown at 1039 to the SA's user GUI device.

The GUI for the IWNMS SA is like the GUI for the customer SA, except that the IWNMS SA's GUI permits the SA to specify operations such as adding and deleting customers and licenses and assigning SIDs.

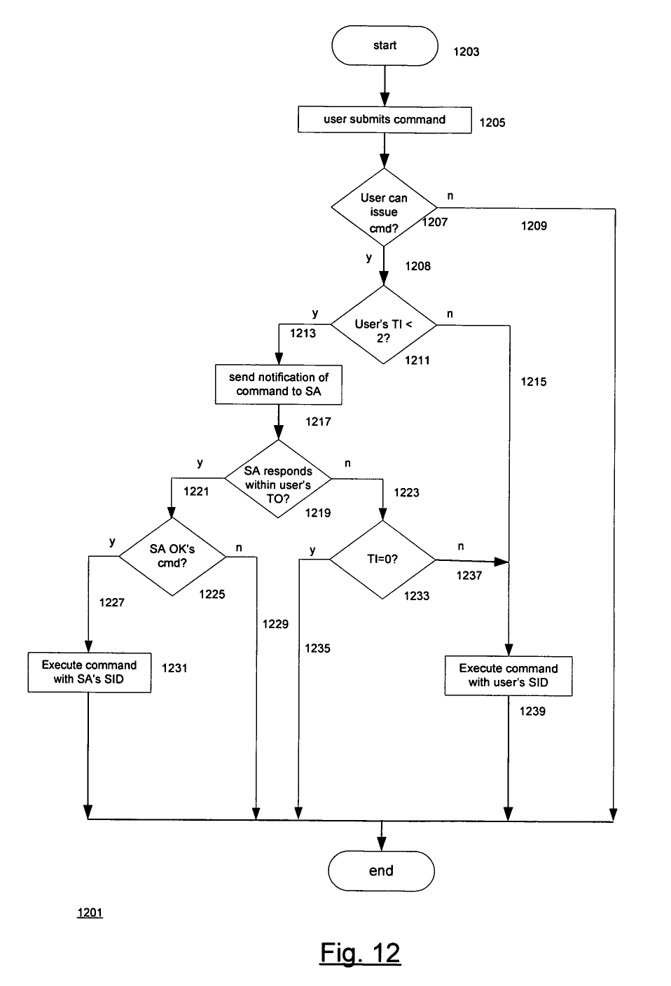

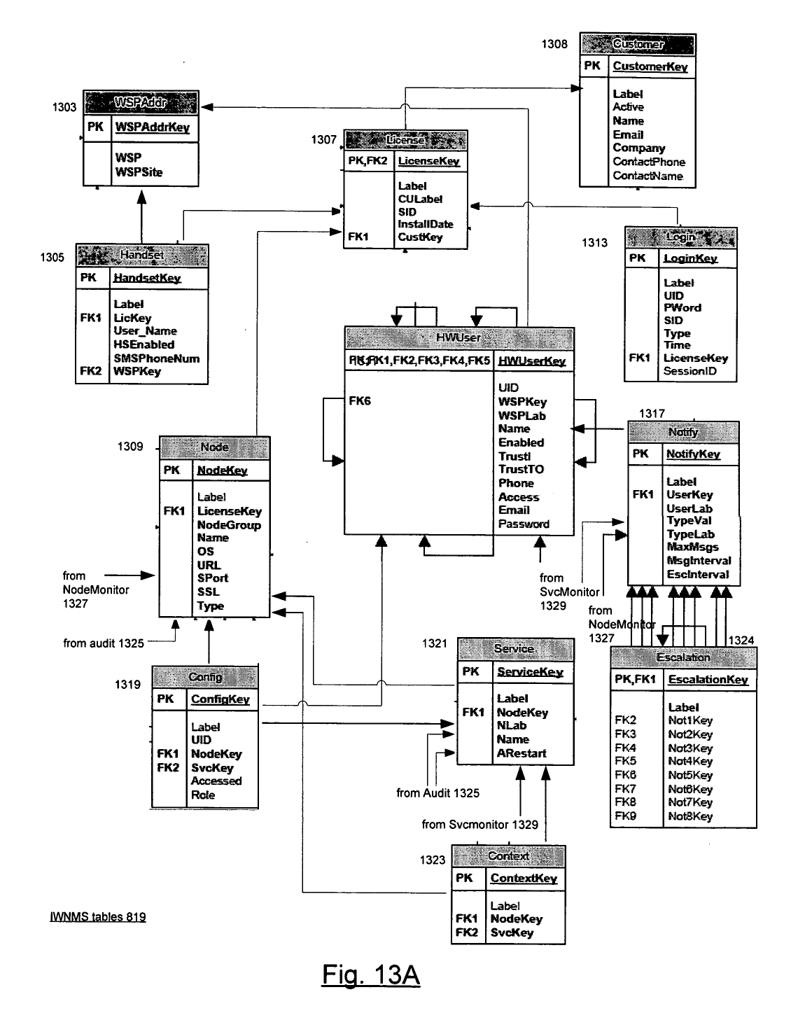

Mediating Commands Made by APs: FIGS. 11 and 12

One of the improvements in improved IWNMS 801 is that a user may be configured so that when the user issues a command to a node or service, an SA determines whether the command will in fact be issued. In the following, this arrangement will be termed mediated execution of commands.

Overview of Mediated Execution

When a user who has been configured for mediated execution of commands submits a command for execution to gatekeeper 811, the SA receives an interactive notification that the user has issued the command and may respond to the notification by indicating whether and/or how the command will be issued. An example of the interactive notification received by the SA is shown at 1139 in FIG. 11B. In this case, the command issued by the user was a command to restart the node cyndi. The notification sets forth at 1141 what the command was, who the user is, and what the user's trust index (TI) is. The trust index is set by the SA for the user and indicates the extent to which the SA trusts the user to execute commands. The notification further sets forth at 1143 the context in which the user is making his request and at 1145 the SA's options in responding. In the preferred embodiment, a TI of 1 indicates that if the SA does not respond to the notification within a configurable period of time (here 20 seconds-see 1145), the command will be executed under the user's user identification (UID). A TI of 0 indicates that the command will be executed only if the SA responds to the notification within the response period and indicates that the command is to be executed. Here, the TI is 1, and as indicated at 1145, if the SA clicks on submit within the response period, the command will be executed under the SA's UID; if the SA clicks on cancel within the response period, the command will not be executed. In other embodiments there may of course be additional trust levels and the levels may have different semantics.

The Logic of Mediated Command Execution

FIG. 12 is a flowchart 1201 of the foregoing. The flowchart assumes only two trust levels for which mediated command execution is required, but the basic logic of the flowchart may be used for any number of levels. In a preferred embodiment, the flowchart's logic is carried out in IWNMS server managed node 813; in other embodiments, it may be carried out in individual managed nodes 821. Beginning at 1203, the user submits a command (1205); next, IWNMS server managed node 813 executes code in gatekeeper services 815 that determines from IWNMS database 817 whether the user has the right to issue the command at all (1207). If not, branch 1209 is taken and the command is not executed. If the user has the right, branch 1208 is taken and the code being executed determines whether the user's TI is less than 2 (1211). If it is not, branch 1215 is taken and the command is executed using the user's SID. If the TI is less than 2, branch 1213 is taken and a notification of the command like the one shown at 1139 is sent to the SA (1217). If the SA responds within TO, which is the configured response period (1219), the code takes branch 1221. In that branch, if the SA OK's the command (1225), branch 1227 is taken and the command is executed with the SA's SID (1231); otherwise, branch 1229 is taken and the command is not executed. If the SA does not respond within TO (1219), the code takes branch 1223. If TI is 0 (1233), branch 1235 is taken and the command is not executed; otherwise, branch 1237 is taken and the command is executed with the user's SID (1239).

In a preferred embodiment, TI may have values ranging from 0 through 10. Each value indicates a degree of trust, ranging from none at all to fully trusted. The manner in which the user command is mediated depends on the degree of trust as follows:

| TI Value | Meaning |
|---|---|
| 0 | No trust; copy to all SAs, gate all commands, ignore |
| | default timeout (TO). |
| 1 | Copy to all SAs, gate until timeout, (default initial |
| | value for user = 1) |
| 2 | Copy to all SAs, gate Test, Restart |
| 3 | Copy to all SAs, gate Restart, |
| 4 | not used |
| 5 | Reserved (alarm) |
| 6 | Copy to customer SA, IWNMS SA, Escalation list, |
| | specified users |
| 7 | Copy to customer SA, IWNMS SA, specified users |
| 8 | Copy to customer SA, specified users |
| 9 | Reserved (alarm) |
| 10 | Fully trusted user |

“to gate a command” in the above table means to perform a mediated execution of the command. It should be pointed out here that the techniques just described could also be used to provide mediation for configuration operations done by SAs.
Configuring Mediated Execution of Commands

FIGS. 11A and 11B show at 1101 how an SA configures mediated execution of commands for a user. In addition to configuring TI and TO for the user, the SA must set it up so that the SA receives the notification, must configure the notification, and must configure the node monitor so that it sends the notification in response to the user's issuance of a node start command. What is being actually configured, of course, is the tables that represent the entities in IWNMS database 817.

Beginning with configuration of the user, this can be done either when the user is added or by modifying the configuration of an existing user. In FIG. 11A, Add User screen 1103 is shown. When the user is added, the SA fills in contact information for the user including user label 1105, which locates the user in the customer managed nodes 821 belonging to the customer, and the user's name, email address, cell phone number, and wireless internet service provider. The SA also fills in TI:TO 1107. The semantics of these fields have already been discussed. If any of the above fields are populated in the database, they are filled in when the screen label is entered.

The next configuration step is setting up an escalation which includes the SAs who are to mediate execution of commands for the user, if one does not already exist. An escalation defines a set of users to which notifications may conditionally be sent. At 1109 is shown the add escalation screen. The screen adds a user to an escalation. At 1111 appears the label for the escalation; if the escalation is new, the SA writes the label into the field; otherwise, the SA uses the drop-down menu to select the escalation to which the user is to be added. User label field 1113 contains the value of a user label field 1105 for a user; again the field's value may be chosen from a drop-down list. Contact type 1115 specifies how the message will be sent, field 1117 specifies the maximum number of messages that will be sent to a user for a given notification, field 1119 specifies the intervals between the messages in minutes, and field 1121 the interval before the message is sent to another level in a hierarchy of escalations that is defined for the notification. There is of course a modify escalation screen which permits any of the above fields to be modified. As is apparent from the foregoing, in a preferred embodiment, a customer SA would define one escalation for TI values 0 through 4 and an escalation each for TI values 6-8.

With the escalation specified, the notification can be configured to add the escalation to the list of escalations to which the notification will be sent. That is done using the Add Notify or Modify Notify screen. Add Notify is shown at 1123. Configuration is done by specifying label values. The first label value, at 1125 is a label for the notify itself; the remaining labels, at 1127, define a hierarchy of escalations. If the notification is not responded to by a user defined at one escalation, it is sent to a user defined at the next escalation within a customer-defined time period. Here, the notification is to be sent only to the SAs, so there will be only a single level of escalation. The escalation selected should of course be the one defined using screen 1109.

With the notification defined, the node monitor that is to return the notification may be configured to add the notification to the list of notifications sent by the node monitor. That is done using Modify Node Monitor screen 1129 in FIG. 11B. At 1131, the monitor to be modified is specified; at 1133, the label of the node the monitor is to monitor is specified; at 1135, the escalation that is to be used by the monitor is specified; at 1137, the intervals at which the monitor is to be executed in the node.

When a user submits his or her command to Gatekeeper 811, IWNMS server managed node 813 first looks at the record for the user in IWNMS database 817 to determine the user's TI and TO values; then it looks at the record for the node's node monitor in IWNMS database 817 to determine the escalation for the node monitor. It then sends the notification shown at 1129 to the user(s) listed in the first escalation level and proceeds as shown in the flowchart of FIG. 12. If the command is executed, it is passed on to the node for which it is destined for execution.

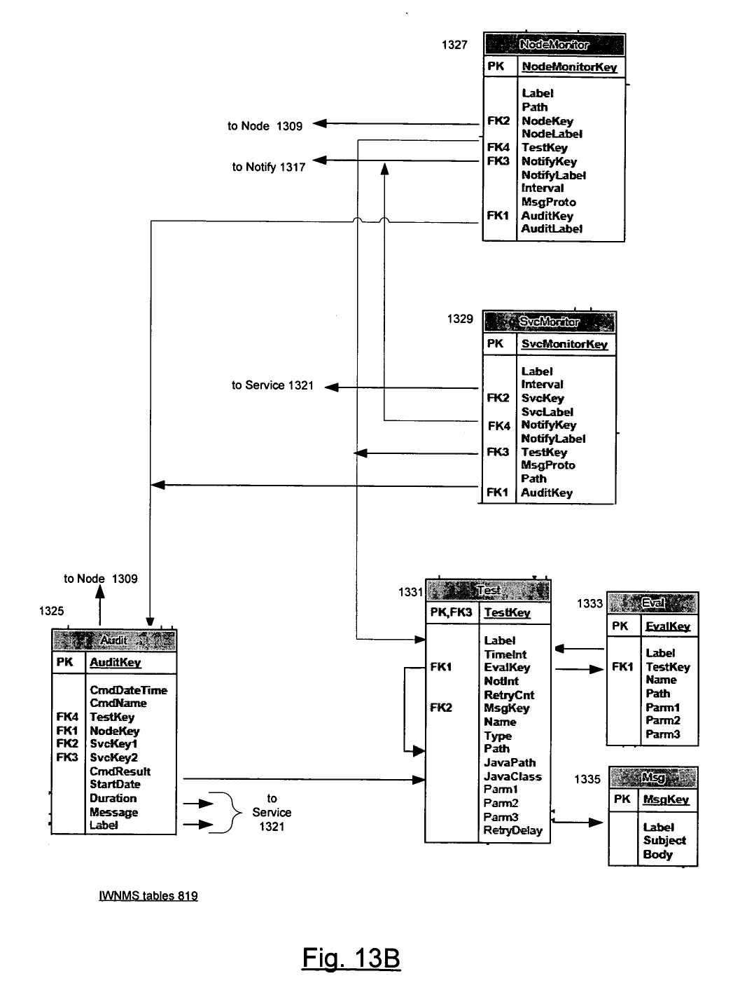

Details of IWNMS Database 817: FIG. 13

IWNMS database 817 is a relational database containing IWNS tables 819 which represent entities in improved IWNMS 801 and relationships between those entities.

Structure of IWNMS Database 817

FIG. 13 is an entity-relationship diagram of those portions of IWNS tables 819 which are relevant to the present discussion. In an entity-relationship diagram, a block such as block 1309 represents a table in the relational database. The table is made up of rows and columns. Each row has a field for each column. At the top of the block is the name of the table, in the case of block 1309, Node. Each row of the Node table represents a managed node in IWNMS 801. Each row contains fields for data that describes the configuration of the node represented by the field. The list following the name of the table in the block representing the table is a list of the names of the table's columns. The values in one of the columns are unique for each row and function as the primary key for the table: given the table name and the primary key, each row can be located. The column that contains the primary key is labeled PK. Some of the other columns may contain foreign keys, that is, primary keys of records in other tables. Foreign keys are labeled FK. In Node table 1309, the column LicenseKey contains foreign keys specifying rows in the table License 1307. The foreign keys indicate relationships between the row of the table that contains the foreign key and a row of the table for which the foreign key is the primary key. In the entity-relationship diagram, arrows connect foreign keys to the tables in which the foreign keys are primary keys; the arrow points from the table that contains the foreign key to the table in which the foreign key is a primary key. Here, there is an arrow pointing from Node table 1307 to License table 1309. In License table 1309, there is a row for each customer license and the field in the LicenseKey column for that row specifies the license for the customer that the managed node belongs to. Because this relationship exists, a query on the Node table that specifies the primary key for a row in License table 1307 will return all of the rows in Node table 1309 for nodes that belong to the customer to whom the license belongs.

There are tables whose rows represent each of the important entities in IWNMS 801; the tables and the entities they represent in FIG. 13A are the following:
WSPAddr table 1303 has a row for each wireless internet service provider 805 used by IWNMS system 801.
Handset table 1305 has a row for each handset.
License table 1307 has a row for each license.
Customer table 1308 has a row for each customer.
Login table 1313 has a row for each user login. The Type field in the row indicates whether the login is for an AP, a customer SA, or an IWNMS SA.
Node table 1309 has a row for each node.

The above tables are related to each other as follows: each row in License table 1307 has a CustKey field which specifies a row in Customer table 1308 for the customer to whom the license belongs; each row in Handset table 1305, Node table 1309, and Login table 1313 has a field which specifies a row in License. As can be seen from this arrangement, each handset, node, and login is associated with a particular license and via the license with a particular customer.

Continuing with the remaining tables in FIG. 13A,
HWUser table 1311 has a row for each user; the row includes a UID field that uniquely identifies the user and a field that specifies a row in WSPADDR table 1303. The value of the UID field is used in rows in other tables to associate the entity represented by the row with the user.
Notify table 1317 has a row for each notification that may be issued to a user; the row includes a field which has the key for the HWUser row for the user.
Escalation table 1324 has a row for each notification belonging to an escalation.
Service table 1321 has a row for each service that is controlled by IWNMS 801. A field in each row of the table has a key for the row in node table 1309 that represents the node the service belongs to.

Continuing with the tables in FIG. 13B, audit table 1309 has a row for each operation that was audited by IWNMS 801.
NodeMonitor table 1327 has a row for each node monitor in IWNMS 801.
SvcMonitor table 1329 has a row for each service monitor in IWNMS 801.
Test 1331 has a row for each test that is available to node and service monitors in IWNMS 801,
Eval 1333 has a row for each evaluation that is available to be performed by tests in IWNMS 801.
MSG 1335 has a row for each message used by a test.

Each node monitor and service monitor is related to the node or service to which it belongs and to the test that is performed by the node or service monitor and each row in Audit table 1309 indicates the node, service, and test that the row is an audit of.

There are also tables that represent important relationships between the tables that represent the entities; thus, Config table 1319 in FIG. 3A has a row for each combination of user, node, and service for which IWNMS is currently configured. This table can be used to quickly determine whether a given user has the right to issue a command for a given node or a given service on the node. If there is no row in the table for the user and node, the user has no right to issue the command for the node; if there is no row in the table for the user, node, and service, the user has no right to issue the command for the given service on the node. Context table 1323 has a row for each combination of node and service that exists in IWNMS 801; this table can be used to quickly determine which Services belong to a given node or which nodes a given service exists in and to locate the rows for those nodes and services in the Node and Service tables.

Contents of Copies 825 of Information from IWNMS Database 817 in Customer Managed Nodes 821

In the copy 825 of IWNS data in a given customer managed node in a presently-preferred embodiment, the tables of IWNMS database 817 contain only those rows that are needed to perform operations in the given customer managed node. Thus, node table 1309 contains a single row, namely the one that represents the given node. License table 1307 also contains only a single row, namely the row for the license to which the node belongs. Handset table 1305 contains only the rows for the handsets for the license to which the node belongs. HWUser similarly contains only the users for the license to which the node belongs. NodeMonitor table 1327 in the copy contains only the rows for node monitor tables that belong to the given node, Service table 1321 in the copy only contains rows for services that belong to the given node, SvcMonitor table 1329 only contains rows for services that belong to the given node, and so on.

IWNMS database 817 and the copies 825 are kept consistent with each other in the presently-preferred embodiment as follows:
When an SA updates IWNMS database 817 in a way that must be replicated in copies 825, IWNMS database 817 is replicated to all of the managed nodes.
There is further code executed by gatekeeper services 815 that periodically checks critical fields in the local database for consistency with IWNMS database 817. If an inconsistency is found, IWNMS database 817 is replicated to all the nodes.
   Use of IWNMS Database 817 in Performing Operations in IWNMS 801

To execute an operation in IWNMS 801, the user must begin by logging in. The first step in logging in is to determine whether the user GUI device from which the user is logging in is recognized by IWNMS 801. When the message from the user GUI device comes in, server 813 determines from Handset table 1305 whether there is a row for the telephone number of the calling device; if there is not, server 813 hangs up; if it is, server 813 uses the LicKey foreign key in the row to locate the row in License table 1307 for the license the handset belongs to and to fetch a unique identifier for the license, the SID, from the row. When the user logs in with his or her password and SID, server 813 queries Login table 1313 to find out whether there is a row in the table that has the password-SID combination (columns Pword, SID) provided by the user; if there is not, the handset is not being used by a user of IWNMS system 801 and server 803 hangs up; if there is such a row, server 813 uses the value of the UID field in the row to query HWUser table 1311 for a row that contains the phone number of the handset and the user's password (columns Phone and Password). If such a row is not found, the handset is not being used by a user of IWNMS system 801; if it is, the row identifies the phone's user.

Once the user has successfully logged on, the user specifies an operation; if the operation is a command, the user's inputs to the GUI specify the command and the node or the node and service that the command is to be applied to. Server 813 queries Config table 1319 to determine whether the user has the right to execute the specified command on the specified node or the specified node and service. If the query does not return a row in Config table 1319 for the user and the specified node or the user and the specified node and service, the user does not have the right to execute the command and the command is not executed. If the user does have the right, server 815 then uses TI and TTO (the TrustI and TrustTO columns) from the user's row in HWUser 1311 to determine whether mediation is required; if it is, it is done as already described.

In either case, if the user has the right to execute the command, server 813 passes a command either from the user or the approving SA to the managed node specified in the command for execution. In that managed node, copy 825 is used to execute the command. For example, if the command is a node test command, copy 825 includes a copy of the row in NodeMonitor table 1327 for the node's node monitor, as well as copies of the row in Test table 1331 that contains the test used by the node's node monitor, of the rows in Notify table 1317 that specify the notifications to be produced by the node monitor, of the rows from HWUser table 1311 for the users specified in the notifications, and of the rows from Escalation table 1324 that specify the escalations for those notifications, and IWNMS customer node services 823 executing on managed node 821 executes the test for the node's node monitor as specified in copy 825 and sends the notification specified for the node monitor and user in copy 825 as specified by the row from HWUser for the user in the copy.

In the case of configuration operations, the SA logs on as described above; then the SA selects admin as shown in screen 911 and the Admin Login screen appears as shown at 1003. The administrator enters his SID and password as administrator, and server 813 proceeds as described above for logins, except that it checks the Type field in the Login row for the user to make sure that the user is an administrator and permits the user to continue only if the user is an SA. The list of operations which the GUI displays for the SA of course depends on whether the SA is a customer SA or an IWNMS SA. The configuration operations are performed on IWNS database 817. It will be generally apparent from the description of the configuration GUI and the description of IWNS database tables 819 what tables are affected by a given configuration operation. Once the configuration change is submitted, server 819 updates the tables in IWNMS tables 819 as required by the configuration operation and then downloads copies of the changes as required by the changes to copies 825 in the managed nodes.

### CONCLUSION

The foregoing Detailed description has disclosed to those skilled in the relevant technologies how to make and use improved IWNMS 801 and has further disclosed the best mode presently known to the inventors for so doing. It will be immediately apparent to those skilled in the relevant technologies that there are many ways other than the one disclosed herein of making and using an IWNMS that employs some or all of the techniques disclosed herein. There are many possible ways of implementing the components of an IWNMS like IWNMS 801 and many ways of representing the components and of configuring the components. With regard to mediated execution of commands, the way in which the mediated execution is done will depend on how the system in which the technique is used is implemented, on what kinds of commands are being mediated, and on the kinds of actions that are available with regard to the message. The kinds of actions that are available may depend on the number of trust values available in the implementation. Any kind of value that serves the purpose may be employed as a trust value.

Thus, for all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. In a system that includes a plurality of nodes, the system being managed by a managing user and having a system operation that may be performed in a node by any user of the system,
a method of performing the system operation for a user in a node, the method comprising the steps performed in the system of:
responding to a first input from the user specifying performance of the operation in the node by obtaining a trust value associated with the user;
when the trust value so indicates, sending a message to the managing user, the message indicating that the user has specified performance of the system operation in the node and the managing user performing an action with regard to the message that indicates how the system operation is to be performed in the node; and
responding to the action by performing the system operation in the node as indicated by the action.

2. The method set forth in claim 1 wherein:
an action of not responding to the message within a predetermined period of time indicates that the system operation in the node is not to be performed.

3. The method set forth in claim 2 wherein:
the predetermined time is associated with the user.

4. The method set forth in claim 1 wherein:
an action of responding to the message within a predetermined period of time indicates that the system operation in the node is to be performed.

5. The method set forth in claim 4 wherein:
the predetermined time is associated with the user.

6. The method set forth in claim 1 wherein:
the action is responding to the message by providing a second input to the system indicating how the system operation is to be performed in the node; and
in the step of responding to the action, responding to the second input by performing the system operation in the node as indicated by the second input.

7. The method set forth in claim 6 wherein:
the second input indicates that the system operation is to be performed in the node for the managing user instead of for the user; and
in the step of responding to the action, the system responds to the second input by performing the system operation in the node for the managing user.

8. The method set forth in claim 6 wherein:
the second input indicates that the system operation is not to be performed in the node; and
in the step of responding to the action, the system responds to the second input by not performing the system operation in the node.

9. The method set forth in claim 1 wherein:
there is a plurality of actions which the managing user may perform with regard to the message; and
the actions include
not responding to the message within a predetermined period of time and
providing a second input to the system in response to the message within the predetermined period of time.

10. The method set forth in claim 9 wherein:
the predetermined time is associated with the user.

11. The method set forth in claim 9 wherein:
in the step of responding to the action,
when the action is not responding to the message, the system responds thereto by performing the system operation in the node for the user and
when the second input indicates that the system operation is not to be performed in the node, the system responds thereto by not performing the system operation in the node.

12. The method set forth in claim 9 wherein:
there is a plurality of the second inputs, including one second input that indicates that the system operation is not to be performed in the node and another second input that indicates that the system operation is to be performed in the node for the managing user; and
the system responds to the one second input by not performing the system operation in the node and to the other second input by performing the system operation in the node for the managing user.

13. The method set forth in claim 9 wherein:
in the step of responding to the action,
when the action is not responding to the message the system responds thereto by not performing the system operation in the node and
when the second input indicates that the system operation is to be performed in the node, the system responds thereto by performing the system operation in the node for the managing user.

14. The method set forth in claim 13 wherein:
there is a plurality of the second inputs, including one second input that indicates that the system operation is not to be performed in the node and another second input that indicates that the system operation is to be performed in the node for the managing user; and
the system responds to the one second input by not performing the system operation in the node and to the other second input by performing the system operation in the node for the managing user.

15. The method set forth in claim 1 wherein:
there is a plurality of the trust values; and
in the step of responding to the action, the manner in which the system responds depends on which trust value of the plurality is associated with the user.

16. The method set forth in claim 15 wherein:
the action is not responding to the message within the predetermined period of time; and
in the step of responding, the system responds when the action is not responding to the message within the predetermined period of time by not performing the system operation in the node when the trust value associated with the user is a first one of the trust values and performing the system operation in the node for the user when the trust value associated with the user is a second one of the trust values.

17. The method set forth in claim 4 wherein:
the predetermined time is associated with the user.

18. The method set forth in claim 16 wherein:
there is a plurality of actions which the managing user may perform with regard to the message;
the plurality of actions includes providing one of a plurality of second inputs to the system in response to the message within the predetermined period of time, the plurality of second inputs including one second input that indicates that the system operation is not to be performed in the node and another second input that indicates that the system operation is to be performed in the node for the managing user; and
the system responds to the one second input by not performing the system operation in the node and to the other second input by performing the system operation in the node for managing user.

19. The method set forth in claim 1 wherein:
the nodes include a first node of the plurality which receives the first input;
the steps of responding to the first input and sending a message to the managing user are performed in the first node; and
the step of performing the system operation in the node is performed in the node specified in the first input.

20. A memory device which is accessible to the system,
the memory device being characterized in that:
the memory device contains code which, when executed by the system, performs the method set forth in claim 1.
